(19) United States
(12) Patent Application Publication
(10) Pub. No.: US 2026/0243650 A1
(43) Pub. Date: Aug. 20, 2026

(54) METHOD FOR AUTOMATED CLASSIFICATION OF POROSITY IN MICROSCOPIC SLIDES AND COMPUTER-READABLE STORAGE MEDIUM

(71) Applicant: PETROLEO BRASILEIRO S.A. - PETROBRAS, Rio de Janeiro (BR)

(72) Inventor: Matheus Augusto Alves CUGLIERI, Macae (BR)

(21) Appl. No.: 19/537,956

(22) Filed: Feb. 12, 2026

(30) Foreign Application Priority Data
Feb. 20, 2025 (BR) 1020250033127

(51) Int. Cl. G01N 15/08; G01N 15/1433

(52) U.S. Cl. CPC G01N 15/088; G01N 15/1433

(57) ABSTRACT

The present disclosure relates to a method for automated classification of porosity in microscopic slides, including the steps of defining (S100) a porosity classification system; obtaining (S200) an image of microscopic slides; binarizing (S300) the image, performing segmentation to distinguish between “pore” and “non-pore” regions; identifying (S400) porous elements (PorEls); segmenting (S500) the constituents of the “non-pore” phase; correlating (S600) the porous and solid elements; applying (S700) geometric parameters, including additional properties of the porous elements (PorEls); classifying (S800) the porous elements (PorEls), assigning to each porous element (PorEl) a final classification according to the reference system; and extracting (S900) the statistical distributions to generate data, computing and storing said quantitative data related to the distribution, frequency and geometric properties of the porous elements (PorEls) for detailed analysis. Additionally, the present disclosure also discloses a computer-readable storage medium including a set of instructions for carrying out the method of the present disclosure.

### CROSS-REFERENCE TO RELATED APPLICATIONS AND CLAIM OF PRIORITY

This application claims the benefit of priority of Application No. 1020250033127, filed in Brazil on Feb. 20, 2025, the complete disclosure of which is incorporated herein by reference.

### FIELD

The present disclosure pertains to the scope of oil exploration and production, specifically in the processes of production, modeling, simulation, and evaluation of reservoirs. In this way, the present disclosure focuses on presenting a new methodology that standardizes the analysis of the porosity through petrographic images and evaluates, on a pixel scale, the relations of the porous elements with their adjacencies, enabling more precise classification and quantification, favoring studies and data analysis. In this sense, the new methodology enables a massive data acquisition, which can support decisions regarding the production of oil reservoirs and make information from these studies available in a timely manner within the oil exploration and production chain, in addition to minimizing user/generator error of this type of information.

### BACKGROUND OF THE DISCLOSURE

The petrographic characterization is a crucial step in oil field studies, being used to acquire knowledge about source rocks, seal rocks and, mainly, reservoir rocks. The microscopic studies aim at the qualification and quantification of solids (mineral phases) and voids (popularly known as “porosity”).

In petrography, the analyzed rock data are summarized in a volume of minute thickness, being considered two-dimensional and randomly oriented (in most cases). The constituents found therein (among them, porosity) are considered two-dimensional sections, representative or not, of the sampled volume. The most technical definition for “porosity” in this context is that of PorEl (“Pore Element”), which refers to a two-dimensional section that captures a more or less complex arrangement of elements of the porous system.

In any case, the characterization of the PorEls involves both the acquisition of quantifiable parameters, such as area and geometric attributes (axis sizes, sphericity, porosity area, etc.), and the classification of the pore type. This classification can vary according to the objective of the study, encompassing different criteria. In general, this classification suggests a genetic origin of the pore, often materialized in its relation with the adjacent constituents, that is, its position and interaction within the rock system.

The porosity presents itself as a diversity of forms, with variable geometric aspects and dimensions, resulting from the sum of processes (geological or not) to which the rock volume has been subjected. The acquisition of this type of information is still carried out in an “artisanal” way, based on the evaluation of the specialist, who obtains as the main product a “relative” quantification of the main types of pores classified, this activity being highly imprecise, as it is susceptible to user biases, as well as fatigue and inaccuracies related to a lack of expertise. Since this type of information has so many points of attention, its use is compromised, and ends up having restricted use in more detailed characterizations.

One of the biggest concerns associated with petrographic classification in the context of oil exploration and production is the precise and faster identification of the reservoir rock characteristics, such as porosity, permeability, and mineralogical composition. These parameters are fundamental to assessing the quality and productive potential of the reservoirs. The geological variability of the formations can make it difficult to carry out consistent analyses, making the use of advanced methodologies indispensable.

In this context, the need arises for the development of automated techniques, such as the use of artificial intelligence and machine learning, aiming at optimizing the process of classification and complete quantification of porosity in microscopic slides, reducing the analysis time and increasing the reliability and uniformity of the results.

### STATE OF THE ART

Document US2022325613 A1 discloses a computer-implemented method that includes: accessing a first input dataset that encodes a plurality of petrophysical properties of a first set of wells in a reservoir; performing one or more petrochemical rock type (PRT) labels at least in part based on the first input dataset; at least in part based on one or more petrochemical rock type (PRT) labels, training one or more models for the reservoir by using one or more machine learning algorithms; accessing a second input dataset that encodes the plurality of petrophysical properties of a second set of wells in the reservoir and applying one or more models to a second input dataset to determine a reservoir characteristic, wherein the second set of wells differs from the first set of wells.

The first input dataset may include one or more measurement records that encode petrophysical properties of rocks. The petrophysical properties may include: porosity, permeability, pore geometry, capillary pressure, and saturation height function. One or more machine learning algorithms may include: a support vector machine (SVM), a self-organizing map, a random forest, an artificial neural network, a convolutional neural network (CNN), a UNet, and a ResNet. One or more models may be configured to perform at least one of the following: regression, classification, clustering, or segmentation. The porosity is intercorrelated with the permeability or relative permeability. The saturation height is intercorrelated with the capillary pressure. The capillary pressure is intercorrelated with the permeability or relative permeability, and the pore geometry is intercorrelated with the rock type. The workflow may access data that includes input core data and log data. The core data may refer to measurements taken on core samples taken from a well site. The SCA data may include capillary pressure measurements, nuclear magnetic resonance spectroscopic data, relative permeability data, and X-ray data (XRD).

The core petrography data may include scanning electron microscopy (SEM) data, thin sections, and core photos. A deep neural network-based regression model can be used to establish a mapping between the input measurements listed above and the output properties targeted by the petrophysical modeling process. Once the model has been trained based on the input training data and then validated based on, for example, validation data, the machine learning models can then be applied to predict porosity/permeability (phi-k), saturation height function (SHF), petrophysical rock type (PRT), simultaneously or individually, from new measurement data.

The method described in the document includes: accessing a first set of input data that encodes a plurality of petrophysical properties from a set of wells in a reservoir; performing one or more petrochemical rock type (PRT) labels; training one or more models for the reservoir using one or more machine learning algorithms. The petrophysical properties may include: porosity, permeability, pore geometry, capillary pressure, and saturation height function. On the other hand, the document is silent regarding the possibility of extracting statistical distributions of properties (area, axis size, roughness, perimeter, etc.), frequency, and spatial distribution of each type of porous element, in order to detail the characterization of the rock.

In this way, document US2022325613 A1 does not provide a solution that directly and reliably correlates the geometric characteristics of the pores, such as size, perimeter, and area, and their genetic classification. Although the state of the art presents classification systems that use geometric attributes, such as division by size, these systems do not establish a precise relation with the genetic type and geometric properties of the pores.

Document US2024193427 A1 discloses a method for predicting the occurrence of a geological feature in a thin-section image, the method comprising the steps of: (a) providing a trained backpropagation-enabled classification process, the backpropagation-enabled classification process having been trained by (i) providing a training set of thin-section images; (ii) determining the scale of each of the thin-section images in the training set; (iii) extracting training image fractions from the training set of thin-section images; (iv) defining a set of geological features of interest, wherein the set of geological features comprises a plurality of classes; (v) selecting a class to label each of the training image fractions; (vi) inserting the extracted training image fractions with associated labeled classes into the backpropagation-enabled classification process; and (vii) iteratively computing a prediction of the class occurrence probability in the extracted training image fractions, and adjusting the parameters in the backpropagation-enabled classification model accordingly, thereby producing the trained backpropagation-enabled classification process; and (b) using the trained backpropagation-enabled classification process to predict the class occurrence in an untrained thin-section image by (i) providing an untrained thin-section image; (ii) determining the scale of the untrained thin-section image; (iii) extracting an untrained image fraction from the untrained thin-section image, the extracted untrained image fraction having the same absolute horizontal and vertical length as the extracted training image fraction used to train the networks; and (iv) inserting the extracted untrained image fractions into the trained backpropagation-enabled classification process; (v) predicting a class occurrence probability in the extracted untrained image fraction; and (vi) combine the probabilities for the extracted untrained image fractions to produce an inference for the occurrence of the class in the untrained thin-section image.

The method predicts the occurrence of each of the classes that characterize a geological feature in a geological thin-section image. A geological feature of interest may include: texture type, grain size, grain type, cement type, mineral type, rock type, pore size, and porosity type. The scale of each image in the training set is determined by the number of pixels corresponding to the length of the graphic scale bar, which is superimposed on the upper part of the image, subdivided by the absolute dimensions that the graphic scale bar represents, which is located next to the graphic scale bar at the upper part of the image, having a characteristic resolution or number of pixels in the horizontal or vertical direction. The untrained image fractions are extracted from an untrained thin-section image, exhibiting the same absolute dimensions as the extracted training image fractions and being fed into a trained backpropagation-enabled classification process. The predictions are produced by showing the probability of occurrence of classes A, B, C, D in extracted untrained image fractions, which are combined to produce an inference of classes A, B, C, D for the untrained thin-section image, helping to identify vertical trends in the frequency or distribution of classes in relation to the depth, and to disclose clues about the capacity of rocks to store and produce hydrocarbons and the best way to extract these resources.

The method described in the document aims to predict the occurrence of a geological feature in a geological thin-section image, using a backpropagation-enabled classification process trained by inserting extracted training image fractions, which have the same absolute horizontal and vertical length and associated markers for classes from a predetermined set of geological features, and iteratively computing a prediction of the probability of occurrence of each of the classes for the extracted training image fractions. On the other hand, the document is silent regarding the possibility of extracting statistical distributions of properties (area, axis size, roughness, perimeter, etc.), frequency, and spatial distribution of each type of porous element in order to detail the rock characterization.

In this way, as can be observed, document US2024193427 A1 does not present an approach to pixel-level classification, although it mentions the pixel as the “basic unit” for image evaluation, that is, there is no reference to the classification considering the adjacent pixels or belonging metrics. The method described in the document uses pixels for advanced image processing, but without mentioning the use of double classification, distinguishing between pores and non-pores and evaluating the “pixel's belonging to the area of a given constituent”. In this sense, in documents of the state of the art, there is no reference to the use of pixel-scale images, performing multiple classifications before reaching the final step, with the aim of defining “genetic classes” of pores.

Document CN117454261 A discloses a method for characterizing the pore structure of the oil reservoir material with the aim of providing a method for evaluating pore structure and its application that combines feature screening algorithms and support vector machine. The pore structure assessment method combines feature screening and SVM algorithm, including the following steps: identifying and characterizing the pore structure types of core samples and classifying the pore structure types of core samples; screening the model input features based on the F-score algorithm and building a sample dataset by means of the core calibration logging; building a pore structure type logging identification model based on the SVM algorithm and selecting test samples to verify the model's generalization performance; combining linear discriminant analysis and backpropagation neural network algorithm to verify the model's performance; the pore structure type prediction model based on the constructed F-score collaborative SVM algorithm is used to identify and apply the drilled wells across the area; based on the identification of logging of single-well pore structure types, the sequential Gaussian simulation method is used to establish a three-dimensional geological model of the pore structure types of the main oil-bearing strata and to predict favorable zones for porosity and permeability development.

The pore structure evaluation method described in the document combines feature screening and SVM algorithm, including identifying and characterizing the pore structure types and classifying the pore structure types, screening model input features and building a sample dataset, building a pore structure type logging identification model, combining linear discriminant analysis and backpropagation neural network algorithm to verify the model performance, and establishing a three-dimensional geological model of the pore structure types, and predicting the favorable zones for porosity and permeability development. On the other hand, the document is also silent regarding the possibility of extracting statistical distributions of properties (area, axis size, roughness, perimeter, etc.), frequency, and spatial distribution of each type of porous element, in order to detail the characterization of the rock.

In this way, as can be observed, document CN117454261 A does not deal with the classification of the porosity, but rather with quantitative and geometric parameters of the void spaces, since the methodology presented in this document addresses to porosity parameters. Many of these parameters are not acquired from petrographic images, but from calculations derived from petrographic analyses that relate porosity and permeability. In addition, despite mentions of the use of algorithms, the document presents little conceptual development on the petrographic and petrological attributes necessary for the classification of the porosity.

As can be observed, despite technological advances and the development of new tools, the state of the art does not disclose a solution capable of performing the automated analysis and classification of the porosity with precision, speed, and uniformity to meet the demands of petrographic characterization of porous reservoir rock systems, using petrographic images, and evaluating, at the pixel scale, the relations of the porous elements with their adjacencies.

The disclosure described below stems from ongoing research in this segment, which aims at developing a solution capable of standardizing the porosity analysis through petrographic images, and evaluating, on a pixel scale, the relations of the porous elements with their adjacencies, using artificial intelligence resources for a complete classification and quantification, favoring studies and data analyses, as well as increasing the precision, reliability, and uniformity of the results.

### OBJECTIVES

The objective of some embodiments of the present disclosure is to offer an automated method for analyzing and classifying porosity in microscopic slides, using advanced technological tools, such as artificial intelligence, aiming at providing greater precision, speed, and uniformity of the results. This method seeks to overcome the limitations of the traditional methods, offering an effective solution for detailed characterization of porous systems in reservoir rocks, optimizing the data acquisition process and reducing the imprecision of the analyses performed by specialists.

In this way, the present disclosure describes an automated method for classifying the porosity through the acquisition of geometric data and the analysis of photomicrographs, that is, images of petrographic slides on a microscopic scale. This method uses advanced techniques, such as artificial intelligence, and allows for the precise identification of the characteristics of the porous systems, ensuring uniformity and reliability in the results.

In addition, the present disclosure standardizes the analysis of the porosity through petrographic images, on a pixel scale, evaluating the relations of the porous elements with their adjacencies and enabling the massive acquisition of data, which can support decisions regarding the production of oil reservoirs and make information from these studies available in a timely manner within the oil exploration and production chain.

### SUMMARY OF THE DISCLOSURE

An aspect of the present disclosure relates to a method for automated classification of porosity in microscopic slides, comprising the steps of:
defining S100 a porosity classification system, wherein a reference system is selected and adapted to a model based on digital images, using fundamental image units, wherein the fundamental image units are represented by pixels and wherein each pixel is classified based on its individual properties and spatial relations with adjacent pixels;
obtaining S200 an image of microscopic slides, wherein the pixel size of the image is smaller than the smallest porosity structure to be identified;
binarizing S300 the image, performing segmentation to distinguish between “pore” and “non-pore” regions based on the color properties,
wherein the pore regions, corresponding to the porous spaces of the sample, are identified by means of predefined color thresholds;
identifying S400 porous elements (PorEls), delimiting each of the porous elements and extracting their geometric properties;
segmenting S500 the constituents of the “non-pore” phase, dividing the solid areas into discrete elements such as grains, particles, and cement, wherein individual labels are assigned to each of these constituents;
correlating S600 the porous and solid elements, performing a spatial analysis of the neighborhood of the porosity pixels in relation to the adjacent pixels of the solid phase to determine the classification of the porosity type based on the predefined spatial interactions;
applying S700 geometric parameters, including additional properties of the porous elements (PorEls), wherein the additional properties include aspect ratio and area distribution;
classifying S800 the porous elements (PorEls), assigning to each porous element (PorEl) a final classification according to the reference system; and
extracting S900 the statistical distributions to generate data, computing and storing said quantitative data related to the distribution, frequency and geometric properties of the porous elements (PorEls) for detailed analysis.

Additionally, the present disclosure also relates to a computer-readable storage medium which, upon receiving a set of instructions, will perform the steps of the method of the present disclosure.

### BRIEF DESCRIPTION OF THE FIGURES

The present disclosure will be better understood from the detailed description and figures described below that refer to the same.

FIG. 1 illustrates an image representation with sufficient resolution to faithfully represent the rock constituents.

FIG. 2 illustrates a binarization representation of the image.

FIG. 3a illustrates a porous element (PorEl).

FIG. 3b illustrates geometric properties to be gathered in the porous element (PorEl).

FIG. 3c illustrates the boundaries of the porous element (PorEl).

FIG. 4a illustrates a representative diagram of a photomicrograph with examples of solid constituent classifications.

FIG. 4b illustrates a representative diagram of a photomicrograph with examples of solid constituent classifications.

FIG. 4c illustrates labeling on the photomicrograph.

FIG. 5a illustrates a segmentation of solid constituents in a binarized photomicrograph.

FIG. 5b illustrates a pixel-level representation of the pixel classification.

FIG. 6a illustrates a representation of the segmentation of ‘non-Pore’ and ‘Pore’ phase elements for identification.

FIG. 6b illustrates a detailed representation of the segmentation of ‘non-Pore’ and ‘Pore’ phase elements for identification of internal porosity and dissolved edges.

FIG. 7a illustrates a spatial correlation of porous elements (PorEls) with solid constituents.

FIG. 7b illustrates in detail a spatial correlation of porous elements (PorEls) with solid constituents.

FIG. 7c illustrates in detail a spatial correlation of porous elements (PorEls) with solid constituents.

FIG. 7d illustrates in detail a spatial correlation of porous elements (PorEls) with solid constituents.

FIG. 7e illustrates in detail a spatial correlation of porous elements (PorEls) with solid constituents.

FIG. 8a illustrates a spatial correlation of porous elements (PorEls) with solid constituents.

FIG. 8b illustrates in detail a spatial correlation of porous elements (PorEls) with solid constituents.

FIG. 8c illustrates in detail a spatial correlation of porous elements (PorEls) with solid constituents.

FIG. 9a illustrates a classification of porous elements (PorEls) based on the belonging labels.

FIG. 9b illustrates in detail a classification of porous elements (PorEls) based on the belonging labels.

FIG. 9c illustrates in detail a classification of porous elements (PorEls) based on the belonging labels.

FIG. 9d illustrates in detail a classification of porous elements (PorEls) based on the belonging labels.

FIG. 10a illustrates a classification of porous elements (PorEls) based on geometric properties.

FIG. 10b illustrates in detail a classification of porous elements (PorEls) based on geometric properties.

FIG. 10c illustrates in detail a classification of porous elements (PorEls) based on geometric properties.

FIG. 10d illustrates in detail a classification of porous elements (PorEls) based on geometric properties.

FIG. 11 illustrates a flowchart of the sequencing of steps necessary to carry out the present disclosure.

### DETAILED DESCRIPTION

The following description constitutes only a preferred embodiment within the scope of the present disclosure.

The present disclosure aims at offering an automated method for analyzing and classifying porosity in microscopic slides, using advanced technological tools, such as artificial intelligence, in order to provide greater precision, speed and uniformity of results.

The methodology addressed by the present disclosure provides a complete step-by-step process for classifying porosity through the analysis of photomicrographs (microscopic-scale images of petrographic slides), based on the main current porosity classification systems published in the literature. The porosity classification, although time-consuming, is of great value for the genetic interpretation of the rocks, being essential for understanding the distribution of voids in the rock and its complete characterization. The possibility of automation, to be achieved through the development of algorithms based on the sequence of steps that will be described herein, tends to promote an effective gain in productivity and quality of acquired information.

In technical terms, what is generically called “porosity” in petrographic slides is defined as “PorEl” (Porous Element), and it is an aggregate with real continuity (for the two-dimensional section represented in the studied slide) of elements of a porous system (porous chambers and pore throats). Such structures, fundamental for the storage and transmission of fluids in a reservoir rock, are consequences of the geological history imposed on that volume of rock, and present features that can aid in this interpretation (geometric properties, dimensions, relations with adjacent mineral phases, etc.).

It is also worth mentioning that, for cases of automation of the proposed methodology, it is essential that the resolution of the images to be used must be sufficient to precisely represent the most representative PorEl modes of the analyzed texture (in other words, that the pixels that make up the image have dimensions smaller than the mode of the porosity existing in the slide/photomicrograph).

In general, classification systems are used that can condense information regarding the genesis and spatial relation of the PorEls with their adjacencies. This classification system must be “translated” to the reality of a digital image, where the fundamental element (pixel) is the reference unit.

Therefore, the first step is to define S100 a porosity classification system, wherein a reference system is selected and adapted to a model based on digital images, using fundamental image units, wherein the fundamental image units are represented by pixels and wherein each pixel is classified based on its individual properties and spatial relations with adjacent pixels.

Below, Table 1 shows examples of porosity classification (PorEls), using the pixels of this porous element as a reference. Table 1 exemplifies this step through two columns: the pore type of the classification system used, and the pixel distribution pattern of the PorEl that meets this classification. The porosity classification system is an intergranular porosity classification system, an intragranular porosity system, a vugular porosity system, and a fracture porosity system.

It is worth noting that this step can be customized by the user, who can use, or even create, a classification system that suits his/her needs. Additionally, the classification system creates or adapts classification tables that relate the porosity types to pixel distribution patterns.

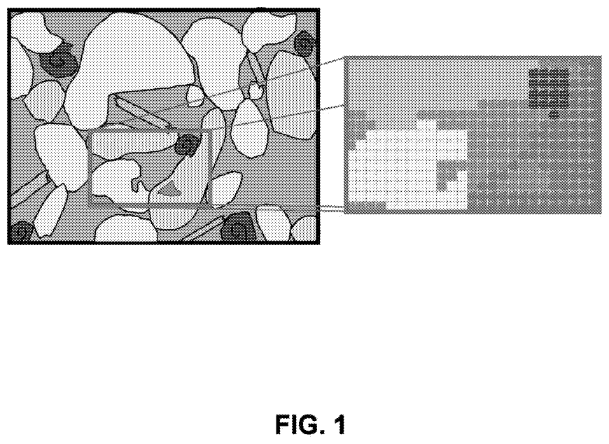

As can be seen in FIG. 1, there is a definition of the material to be used (photomicrographs-microscopic images). It is necessary to obtain images with sufficient resolutions to faithfully represent the rock constituents.

FIG. 1 highlights the pixel size small enough to precisely represent all existing PorEls modes in the image field. FIG. 1 is a representation of a photomicrograph, not to scale, of a granular rock texture, in which different grains are in contact and, between them, empty spaces occur (porosity, in blue color). In detail (red rectangle), a view of the regular, gray-colored square mesh would represent the image pixels, in which it is possible to obtain S200 an image of microscopic slides, wherein the pixel size of the image is smaller than the smallest porosity structure to be identified, that is, the smaller the pixel dimensions, the more defined the image.

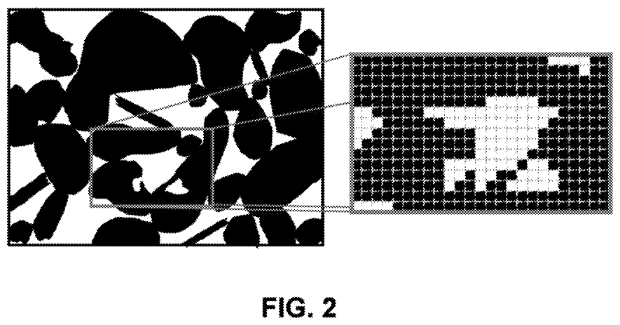

As can be seen in FIG. 2, the next step is to binarize S300 the image, performing segmentation to distinguish between “pore” and “non-pore” regions based on the color properties.

This step S300 aims to separate what is “pore” (void/non-solid) from what is “non-pore” (mineral phases). Generally, petrographic slides of reservoir rocks are impregnated with colored resin (preferably blue), which causes the rock's porosity to exhibit characteristic coloration (with varying shades, according to the crystallinity, granulometry, impregnation effectiveness, etc.). As a general trend, the pore regions, corresponding to the porous spaces of the sample, are identified by means of predefined color thresholds. This process is carried out by a series of programs and algorithms available online, or in free applications (e.g., defining RGB thresholds—Red, Green, Blue—to encompass the shades related to the porosity). In practice, this binarization is nothing more than assigning a “Pore” or “non-Pore” label to each pixel of the image, according to its color properties. FIG. 2 shows an example of binarization, in which all mineral constituents are colored with a specific color (black), and the porosity is identified as another segment (in white). In the detail of FIG. 2, there is a view, in a square pixel mesh, of this binarization.

Then, the next step is to identify S400 porous elements (PorEls), delimiting each of the porous elements and extracting their geometric properties, whose geometric properties of the porous elements (PorEls) include area, perimeter, shape parameters, perimeter-to-area ratio, and aspect ratio.

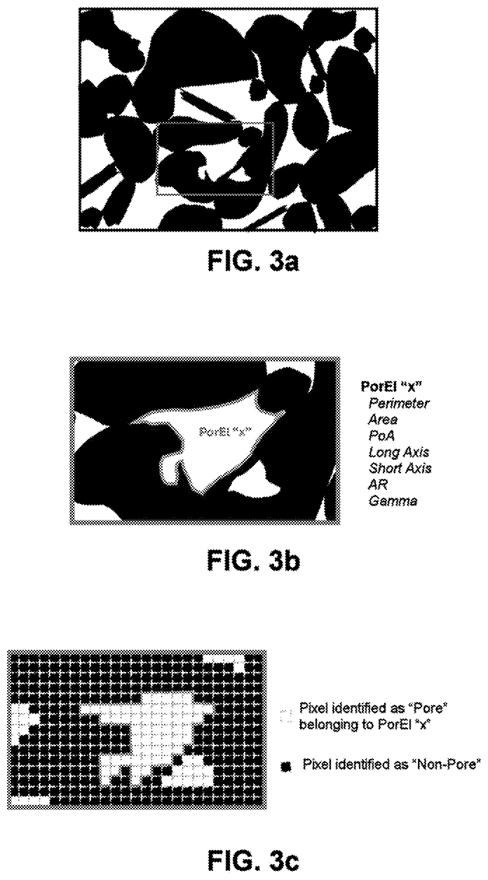

Once the image is binarized, there are two phases (segments) in the image: one related to solids (non-Pore) and the other related to voids (Pore), which are distributed as areas of various shapes and sizes. It is fundamental that each individualized perimeter of the “Pore” segment be considered as an element (by definition, a “Pore Element” or “PorEl”). For each PorEl, extract its typical geometric properties (area, perimeter, perimeter/area ratio (PoA), aspect ratio, gamma) in order to foster a quantification database (to be used in later steps). In practice, each pixel assigned as “Pore” receives a specific label for each PorEl (i.e., in addition to the “Pore” label, the pixel would receive a designation of “belonging to PorEl x”, where “x” is the number of the identified PorEl). FIGS. 3a, 3b, and 3c demonstrate, in an identified PorEl, some geometric properties to be gathered. In terms of pixels, the detailed representation shows that those identified as “Pore” receive the label “belonging to PorEl x”, detailed in FIGS. 3b and 3c. The perimeter in blue, marked in both FIGS. 3b and 3c discloses the PorEl (pore wall) boundaries, and these are given by the edges of the outermost pixels.

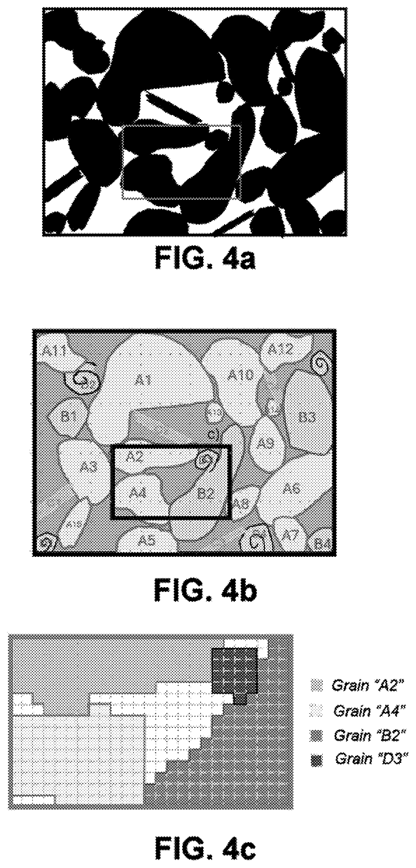

As can be seen in FIGS. 4a, 4b, and 4c, the next step is to segment S500 the constituents of the “non-pore” phase, dividing the solid areas into discrete elements, such as grains, particles, elements, cement, etc., wherein individual labels are assigned to each of these constituents. Said segmentation is performed by using artificial intelligence algorithms trained to recognize mineralogical and textural patterns.

It is important to emphasize that the boundaries are well established so that the classification of these constituents is precise. FIGS. 4a, 4b, and 4c show a representative diagram of a photomicrograph, with examples of classifications of solid constituents, as highlighted in FIGS. 4a and 4b. There are several ways to perform this step, from manual assignment by a user to the application of machine learning algorithms for pattern recognition. In the last case, extensive training of the algorithms is recommended, in order to contemplate as many variations as possible (in size, nuances of internal structures, coloration, etc.) associated with the geological context, artifacts from the preparation of the petrographic slide and limitations of photo documentation, and which do not promote the modification of the imposed label. It is also interesting that each identified class (e.g., “grain”) has its elements individualized: within the class of “grains” (“A”, “B”, “C”), each closed perimeter would represent a specific grain (e.g., “grain A1”, “grain A2”, “grain A3”, etc., representing several individualized grains of the same nature).

In practice, within the “non-Pore” phase, all types of constituents would be discretized. Each pixel assigned to “non-Pore” would receive another label, associated with its belonging to a certain segment of “non-Pore”, for example: the pixels that, in the photomicrograph, make up “grain A1” receive the label that relates the same to “grain A1”, as illustrated in FIG. 4c.

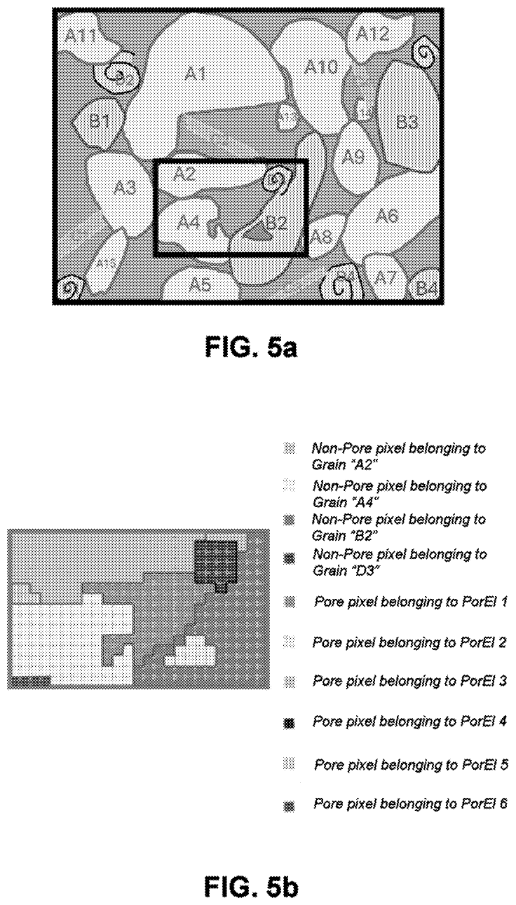

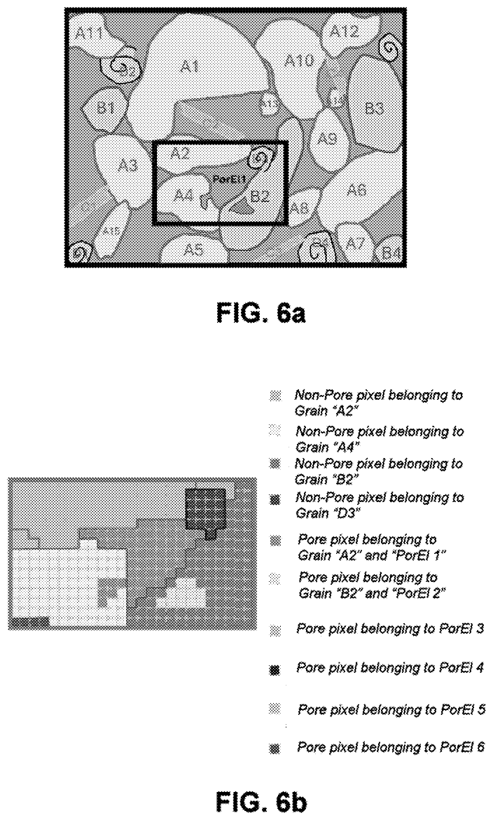

Like PorEls, each element of each “non-Pore” segment must have its geometric properties quantified. The step S500 is crucial for the success of the proposed methodology, and has two main approaches, as illustrated in the sequence of FIGS. 5a, 5b, 6a, and 6b.

In FIG. 5a, the segmentation of the “non-Pore” constituents-once the photomicrograph is binarized, only the pixels identified as “non-Pore” participate in the segmentation into elements/structures. This approach is more easily reproduced through automation algorithms, as it links the identified element to the characteristics of the solid material that composes the same. It is possible to note, from FIG. 5a, that the perimeter of the solids identified as diverse constituents: “A2”, “A4”, “B2”, “D3” comprises only pixels identified as “non-pore”. This is evident in the case of constituents “A4” and “B2”, in which in the case of “A2”, the perimeter of the constituent acquires an indentation profile resulting from the porosity (blue coloration phase) that appears to “penetrate” the constituent. In turn, in “B2”, the pore is isolated within the constituent, and its pixels are not considered part of the same. In the detail of FIG. 5b, there is shown the pixel-level representation of how the classification of pixels would work following this approach: each solid constituent is composed of its respective pixels identified as “non-pore”, while the different PorEls are individualized according to their areal continuity.

The segmentation into elements/structures occurs on both pixels identified as “non-Pore” and “Pore”, as shown in FIGS. 6a and 6b. This approach attempts to account for any elements/structures that have undergone fragmentation and/or dissolution, resulting in internal porosity or dissolved edges. In terms of automation, it is up to the user to establish algorithms that, in addition to identifying the solid element based on a smaller volume of data, are able to infer the original boundaries of that element, an activity that is not always easy.

If it is chosen to perform this activity manually, it would add considerable time to the activity (depending on the number of such cases in the studied photomicrograph). It is worth noting that, if this approach is chosen, the pixels identified as belonging to the “pore” segment, which already have a label related to the respective PorEl to which they belong, receive a new label that expresses a relation of belonging (or not) to a certain constituent of the “solids” phase, e.g., “contained within the perimeter of grain A”, “not contained within the perimeter of solids”, detailed in FIG. 6b. It is possible to note that, from the example in the figure, the perimeters of the solid constituents (“A2”, “A4”, “B2”, and “D3”) are distinct from the approach exemplified by FIGS. 5a and 5b, especially the constituents “A4” and “B2”, which incorporate, within the area limited by the perimeter of the constituent, a sub-area occupied by porosity-represented as some pixels in the example. In FIGS. 6a and 6b, two examples are noted: one related to internal porosity within a constituent connected to the porosity between constituents (“A4”), in which the pixels identified as porosity (blue coloring) located in a concave area of the perimeter of constituent “A4” were labeled both as “belonging to PorEl 1” (given its areal continuity with the same) and “belonging to the area identified as “Grain A4””. This interpretation of constituent area composed of both solids and porosity (with the necessary inference of the original perimeter of the constituent) is an arduous task, especially in attempts at automation.

In this case, it is concluded that “PorEl 1” is composed of subareas with different contexts (in this case, one context “between constituents”, and another “within a constituent”. The second case is typified by constituent “B2”, which has an isolated pore within its perimeter. This pore is defined as a Specific PorEl, which has the same characteristic for each pixel: “belonging to PorEl 2 and belonging to “Grain B2””.

The next step consists of correlating S600 the porous and solid elements, performing a spatial analysis of the neighborhood of the porosity pixels in relation to the adjacent pixels of the solid phase to determine the classification of the porosity type based on the predefined spatial interactions, in which S601 pixels adjacent to the porous elements (PorEls) are evaluated to determine their spatial allocation, identifying whether they are intergranular, intragranular or isolated.

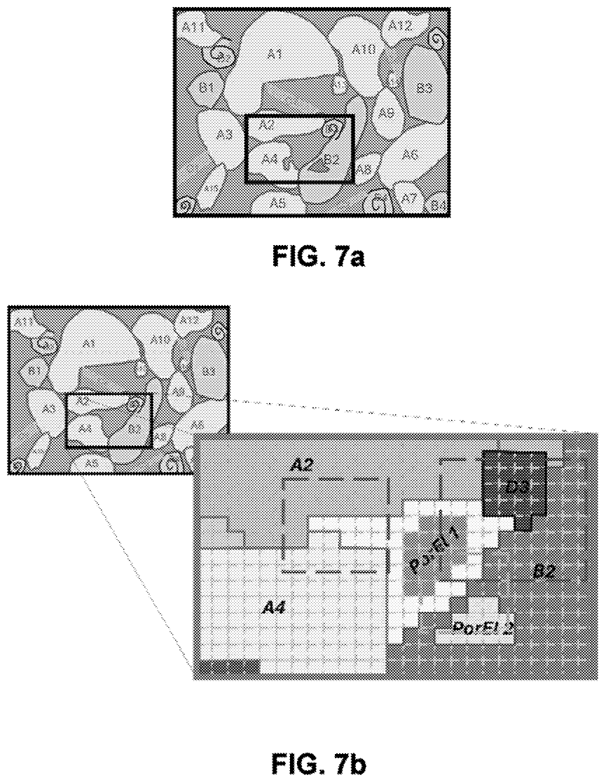

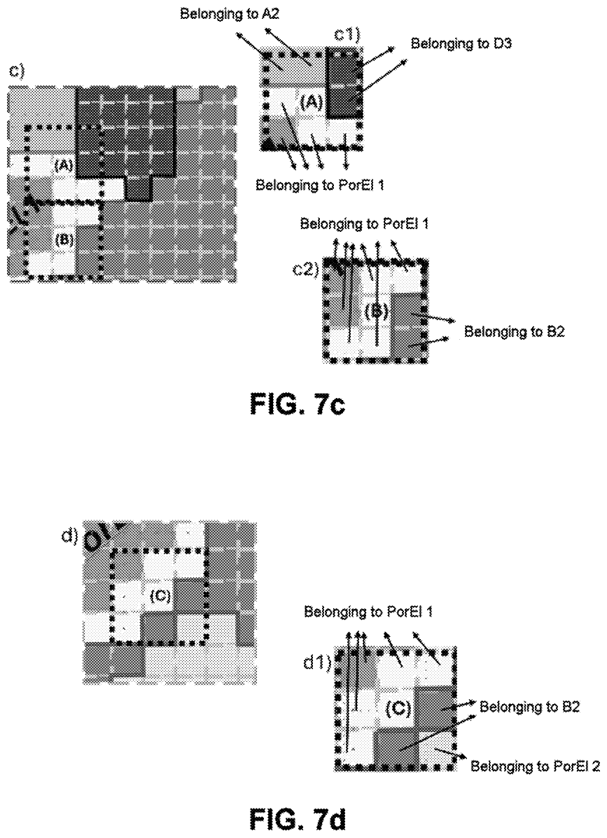

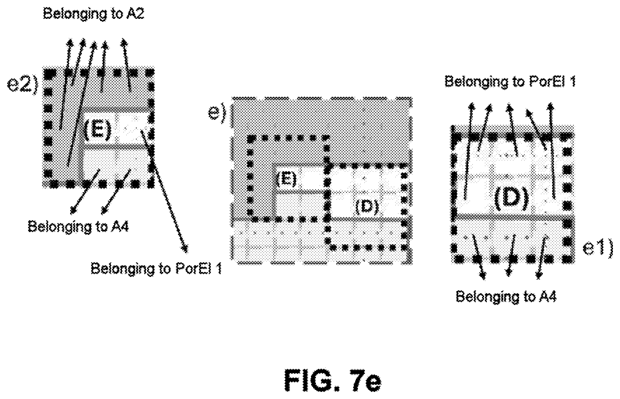

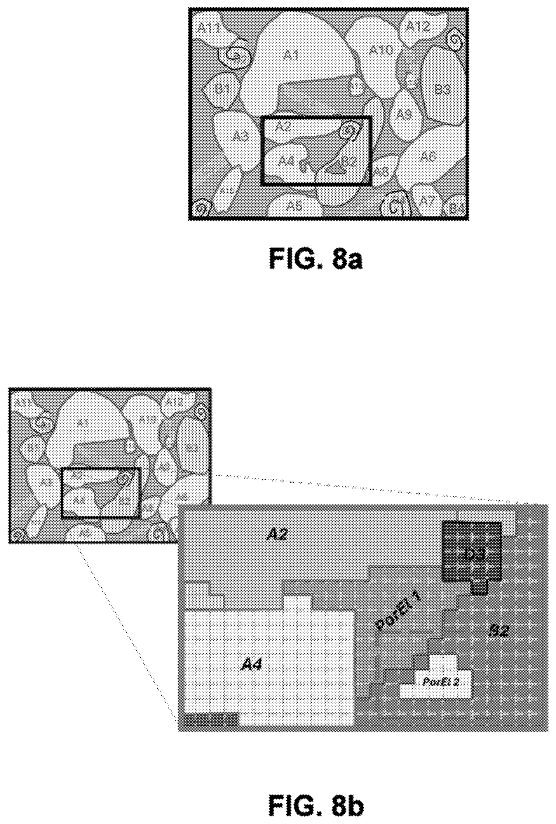

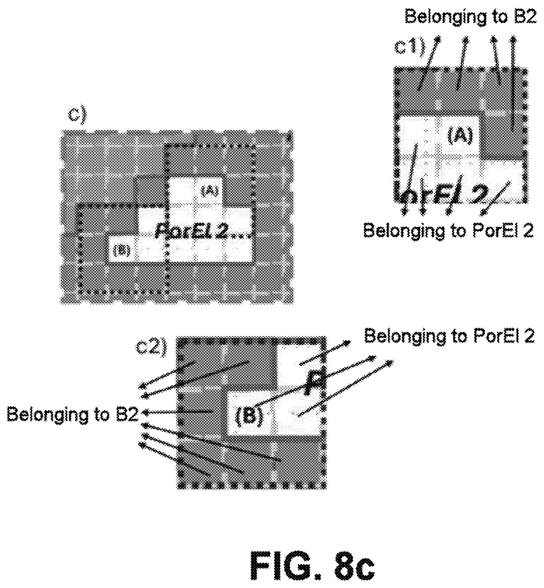

In this step S600, the two levels of information obtained from the binarization and segmentation of the binarized phases will be articulated. Each pixel of the image, labeled as “Pore” and the respective “PorEl” of which it is a part, or as some solid phase and its respective “constituent” will be spatially correlated, according to two ways, which may be articulated, as illustrated in the sequencing of FIGS. 7a, 7b, 7c, 7d, 7e and in the sequencing of FIGS. 8a, 8b, and 8c.

In the sequence of the aforementioned figures, there is a gathering, for each PorEl, in its outermost pixels (the pixels that represent the contact with the “pore wall”): what are the labels of the adjacent “non-Pore” pixels. For each PorEl boundary pixel (in yellow in FIGS. 7b, 7c, 7d, 7e and 8b and 8c), its eight adjacent neighbor pixels must be analyzed (four edge neighbors, and four vertex neighbors highlighted in dotted lines in the examples of the aforementioned figures).

Each of these neighbors is evaluated as to its “belonging label” (e.g., “belongs to PorEl x”, “within the perimeter of constituent A”). It is evaluated, on the total amount of neighbors, which neighbor(s) it is/are, in terms of identifying “non-Pore” labels. Depending on the result, the classification of the type of that PorEl is assigned, according to the rule established in step S100. FIGS. 7a, 7b, 7c, 7d, and 7e exemplify this process, considering five cases (c1, c2, d1, e1, e2) of pixels classified as “pore” in contact with pixels of another nature.

In dotted line, there is the perimeter of the immediately neighboring pixels, for each case (the reference pixel is named with (A), (B), (C), (D), (E)). Note, for the example cited, the various labels of the adjacent pixels in the five cases shown, which shows the “interconstituent” nature of this PorEl (second example of the classification table mentioned in step I).

FIGS. 8a, 8b, and 8c show another example, with a simpler case, where the outermost pixels of the PorEl have the same classification (“belonging to B2”), which suggests a PorEl entirely contained within the perimeter of constituent B2, that is, an intraconstituent PorEl, as exemplified in Table 1.

Additionally, each PorEl will have an internal evaluation of the labels assigned to its pixels. If the labels related to the pixel's “belonging” are all the same, the PorEl has a selective character, and its classification will be according to the table loaded in step S100; if there is variation in these belonging relations, the PorEl has a non-selective character and a different classification, also assigned through the rules established in the table loaded in step S100.

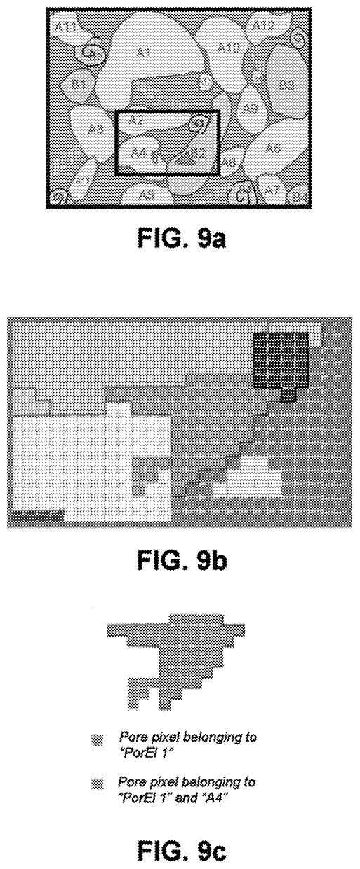

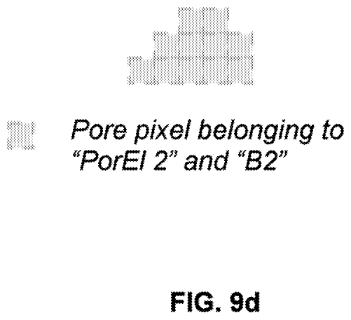

In the example illustrated in the sequence of FIGS. 9a, 9b, 9c, and 9d, two cases are presented: in FIG. 9c, the PorEl consists of pixels classified as pores belonging only to the perimeter of PorEl 1, and pixels classified as pores also belonging to the perimeter of constituent A4. This indicates that there are two porosity allocation groups for the same PorEl, highlighting its non-selective character. On the other hand, in FIG. 9d, a simple case is exemplified, in which the PorEl consists of pixels with the same belonging relations (belonging to PorEl 2 and belonging to constituent B2), indicating the selective character of this PorEl.

Next, geometric parameters are applied S700, including additional properties of the porous elements (PorEls), in which the additional properties include aspect ratio and area distribution, wherein additional geometric parameters, including circularity, elongation and fractal dimension, can be used to improve the classification of the porous elements (PorEls).

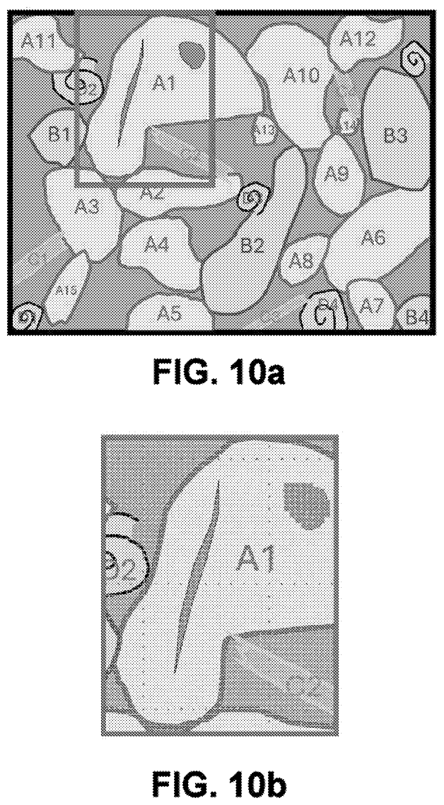

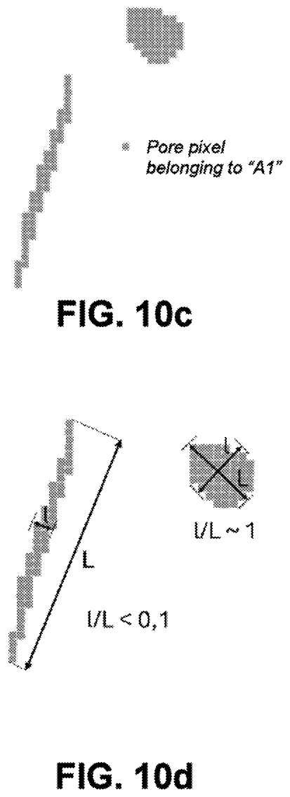

If the relation of the PorEl's pixels with their adjacencies is not sufficient for the classification of that element, other gathered information can be used, such as, for example, the size (area) of the PorEl, or its aspect ratio. This is because certain pore types are also defined by their geometric characteristics, as exemplified in the sequence of FIGS. 10a, 10b, 10c, and 10d and in Table 1. In FIGS. 10a, 10b, 10c, and 10d, there is an example of a case where the complete classification of the PorEls is possible only through the evaluation of geometric properties (in this case, Aspect Ratio—short axis/long axis). Both the identified PorEls have pixels with the same belonging relations (belonging to the respective PorEls and to constituent A1), but their geometric characteristics are essential for classification. In this case, the ratio between the axes of these PorEls was sufficiently indicative for the classification of the porosity, according to the classification table inserted in step S100.

Next, it is possible to classify S800 the porous elements (PorEls), assigning to each porous element (PorEl) a final classification according to the reference system.

Once the PorEls are classified, it is possible to extract S900 statistical distributions of properties (area, axis size, roughness, perimeter, etc.), frequency and spatial distribution of each type of PorEl, in order to detail the characterization of the rock, wherein the data extracted in step S900 can be stored in a database to perform S901 automated statistical analyses and visualization of results, wherein the statistical analysis includes a spatial distribution of the porosity, frequency histograms and mapping of geometric trends in the photomicrograph.

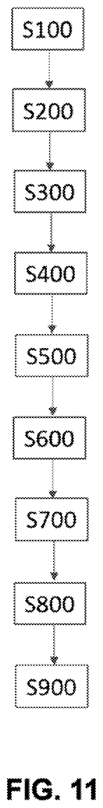

FIG. 11 illustrates a flowchart representing the sequencing of the steps for carrying out the present disclosure.

Based on the same concept as the previous method embodiment, an embodiment of this application further provides a computer-readable storage medium. The computer-readable storage medium stores a set of instructions. When the computer program instructions are loaded and executed on a computer, the procedures or functions according to embodiments of the present disclosure are wholly or partially generated.

A computer can be a general-purpose computer, a dedicated computer, a computer network, or any other programmable apparatus. The computer instructions can be stored on a computer-readable storage medium or transmitted from one computer-readable storage medium to another. For example, the computer instructions can be transmitted from one site, computer, server, or data center to another site, computer, server, or data center in a wired manner (e.g., a coaxial cable, a fiber optic cable, or a digital subscriber line (DSL)), or wirelessly (e.g., infrared, radio, or microwave). The computer-readable storage medium can be any usable medium accessible by the computer, or a data storage device, such as a server or data center, integrating one or more usable media. The usable medium can be a magnetic medium, an optical medium, a semiconductor medium, or the like.

What is claimed is:

1. A method for automated classification of porosity in microscopic slides, the method comprising:
defining (S100) a porosity classification system, wherein a reference system is selected and adapted to a model based on digital images, using fundamental image units, wherein the fundamental image units are represented by pixels and wherein each pixel is classified based on its individual properties and spatial relations with adjacent pixels;
obtaining (S200) an image of microscopic slides, wherein the pixel size of the image is smaller than the smallest porosity structure to be identified;
binarizing (S300) the image, performing segmentation to distinguish between “pore” and “non-pore” regions based on the color properties;
wherein the pore regions, corresponding to the porous spaces of the sample, are identified by means of predefined color thresholds;
identifying (S400) porous elements (PorEls), delimiting each of the porous elements and extracting their geometric properties;
segmenting (S500) the constituents of the “non-pore” phase, dividing the solid areas into discrete elements, such as grains, particles, and cement, wherein individual labels are assigned to each of these constituents;
correlating (S600) the porous and solid elements, performing a spatial analysis of the neighborhood of the porosity pixels in relation to the adjacent pixels of the solid phase to determine the classification of the porosity type based on the predefined spatial interactions;
applying (S700) geometric parameters, comprising properties of the porous elements (PorEls), wherein the additional properties include aspect ratio and area distribution;
classifying (S800) the porous elements (PorEls), assigning to each porous element (PorEl) a final classification according to the reference system; and
extracting (S900) the statistical distributions to generate data, computing and storing said quantitative data related to the distribution, frequency, and geometric properties of the porous elements (PorEls) for detailed analysis.

2. The method according to claim 1, wherein the porosity classification system is an intergranular porosity classification system, an intragranular porosity system, a vugular porosity system, a fracture porosity system, or a user-customized system.

3. The method according to claim 1, wherein the classification system creates or adapts classification tables that relate the porosity types to pixel distribution patterns.

4. The method according to claim 1, wherein the geometric properties of the porous elements (PorEls) comprise area, perimeter, shape parameters, perimeter-to-area ratio, and aspect ratio.

5. The method according to claim 1, wherein the step of segmenting (S500) the constituents of the “non-pore” phase is performed by means of artificial intelligence algorithms trained to recognize mineralogical and textural patterns.

6. The method according to claim 1, wherein the step of correlating (S600) the porous and solid elements further comprising evaluating (S601) pixels adjacent to the porous elements (PorEls) to determine their spatial allocation, and identifying whether they are intergranular, intragranular or isolated.

7. The method according to claim 1, wherein the step of applying (S700) geometric parameter, further comprising geometric parameters are used, comprising circularity, elongation and fractal dimension, to enhance the classification of the porous elements (PorEls).

8. The method according to claim 1, wherein the data extracted in step (S900) are stored in a database to perform (S901) automated statistical analyses and visualization of results, wherein the statistical analysis contemplates a spatial distribution of porosity, frequency histograms, and mapping of geometric trends in the photomicrograph.

9. A computer-readable storage medium, comprising a set of instructions, wherein, when the set of instructions is executed on a computer, it causes the computer to carry out the method according to claim 1.
